(19) United States
(12) Patent Application Publication
(10) Pub. No.: US 2013/0140115 A1
(43) Pub. Date: Jun. 6, 2013

(54) Method for Setting the Play in a Hydraulic Brake System, in Particular for a Motor Vehicle

(71) Applicant: Ralph Gronau, Wetter (DE)

(72) Inventor: Ralph Gronau, Wetter (DE)

(73) Assignee: Continental Teve AG & Co. oHG, Frankfurt (DE)

(21) Appl. No.: 13/697,427

(22) PCT Filed: May 11, 2011
(86) PCT No.: PCT/EP2011/057602

§ 371 Date: Jan. 22, 2013

(30) Foreign Application Priority Data
May 12, 2010 (DE) 102010028909.4

(51) Int. Cl. F16D 65/72

(52) U.S. Cl. CPC F16D 65/72
USPC 188/196 A

(57) ABSTRACT

A method for adjusting the brake play of a hydraulic brake system, for a motor vehicle having at least one brake caliper with a brake piston, a hydraulic pump connected with a brake caliper, and an electric motor driving the hydraulic pump. The following steps are performed: detecting a first rotational position of a pump part by a position sensor and generating a reduced pressure in the pressure chamber, which causes the piston to reset, by suction of a volume of the brake medium determined by a predefined target rotational angle of the pump part, via a suction-side hydraulic connection with the pressure chamber, By controlling the electric motor by means of a PWM signal the predefined target rotational angle of the pump part causes a rotation of the pump part into a second rotational position, wherein the controlled variable is determined depending on the deviation of the actual rotational angle, determined based on the second rotational position, from the target angle.

### CROSS-REFERENCE TO RELATED APPLICATIONS

This application claims priority to German Patent Application No. 10 2010 028 909.4, filed May 12, 2012 and PCT/EP2011/057602, filed May 11, 2011.

### FIELD OF THE INVENTION

The present invention concerns a method for setting the brake play in a hydraulic brake system, in particular for a motor vehicle.

### BACKGROUND AND SUMMARY OF THE INVENTION

In motor vehicle brake systems, in particular with disc type brakes, after a braking process a residual braking effect can occur when the return forces on the brake piston of the brake caliper are not sufficient to lift the brake pads sufficiently far from the brake rotor. The friction force thus generated unfavorably affects the fuel consumption of the motor vehicle.

To solve this problem, in part, a roll-back seal has been developed which moves the brake piston and with it the brake pad away from the brake rotor after the end of the braking process. However the roll-back capacity of the sealing ring on the brake piston is limited and is not sufficient to compensate for contamination, ageing and elastic deformations in the brake caliper and on friction linings. Furthermore, to create the roll-back (also called play), this piston seal has a very high tolerance so that as a result an adequate brake play is not always guaranteed.

DE 10 2008 051 316 A1 discloses a brake system for motor vehicles in which, by means of a reduced pressure of the hydraulic pressure medium in the hydraulic supply line to a wheel brake, brake play can be generated or set so that by means of the reduced pressure, the brake piston of a wheel brake can be actively reset, wherein the amount of the reduced pressure and its duration lead to a defined adjustment of the piston and hence a defined brake play. The reduced pressure can be generated either by means of the master brake cylinder or by means of an additional assembly which is connected with the hydraulic supply line of the wheel brake concerned.

The disadvantage of this known method lies in the risk that the brake piston will be retracted too far, whereby in an emergency situation, too long a brake pedal travel would be required which would lead to a loss of braking power or a delay in brake application.

The object of the present invention is to refine this known method for adjusting the brake play of a hydraulic brake system such that a defined brake play setting can be achieved under all operating conditions.

This object is achieved by a method with the features described in this specification and shown in the appended drawing figures.

The method for setting the brake play of a hydraulic brake system, in particular for a motor vehicle in accordance with this invention is used with a braking system which includes:
at least one brake caliper with a brake piston which can be brought into friction engagement with a brake means,
a hydraulic pump which can be hydraulically connected with a pressure chamber of the brake caliper to move its brake piston, and
an electric motor driving the hydraulic pump, which sets in rotational motion pump parts which can rotate to deliver brake medium.

According to the invention the following method steps are performed:
a) detection of a first rotational position of a pump part by means of a position sensor associated with the hydraulic pump,
b) generation of a reduced pressure in the pressure chamber, which causes a piston reset, by suction of a volume of the brake medium determined by a predefined target rotational angle of a pump part, from the pressure chamber via a suction-side hydraulic connection with the pressure chamber, in that
   by controlling the electric motor in stepper motor operation by means of a PWM (pulse width modulation) signal as a controlled variable, the predefined target rotational angle of the pump part causes a rotation of the pump part into a second rotational position, wherein
   the second rotational position is detected by means of the position sensor, and
   the controlled variable is determined depending on the deviation of the actual rotational angle, determined based on the second rotational position, from the target rotational angle.

The method according to the invention is characterized below in that by means of a position sensor arranged in the hydraulic pump, the rotational angle of a rotation of the hydraulic pump caused by a PWM signal, and hence also the position of the pump piston, can be determined precisely. With this rotational angle determined from the sensor signals of the position sensor, therefore also the volume of the brake medium drawn in from the pressure chamber of the brake caliper is known, which corresponds to a specific brake play. By controlling the electric motor in stepper motor operation, the volume drawn in from the pressure chamber is portioned sufficiently small for the desired brake play to be set precisely.

Preferably the position sensor can be arranged both in or on the hydraulic pump or also on or in the electric motor, wherein in particular an inductive sensor is suitable for this.

The method according to the invention is implemented as an algorithm in the brake control unit of the brake system so that for its implementation—apart from the pump position sensor—no additional components are required.

### BRIEF DESCRIPTION OF THE DRAWINGS

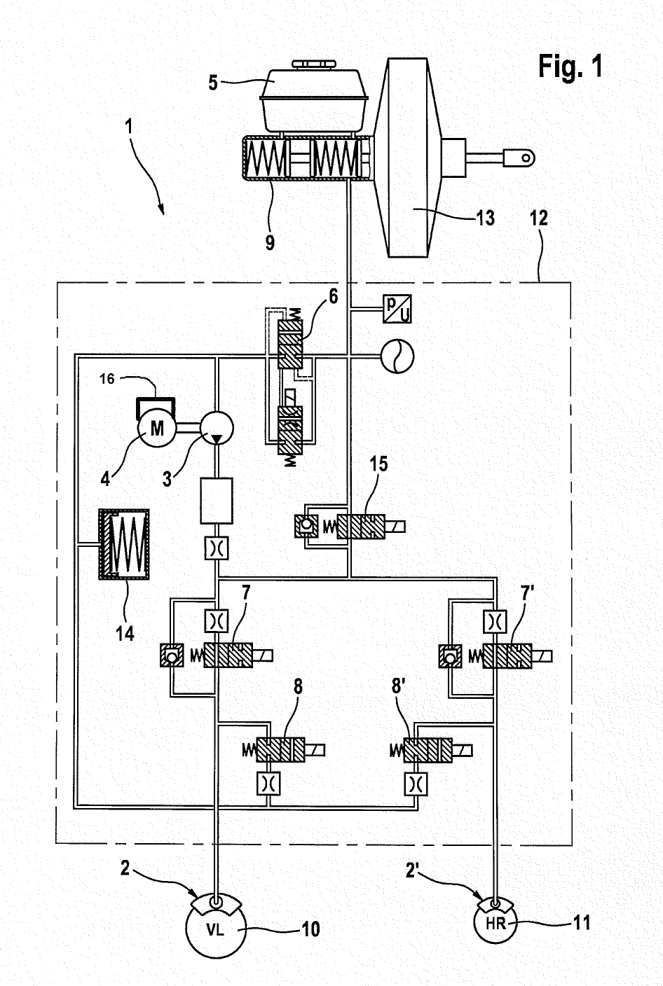

The method according to the invention is explained and described in more detail below with reference to the only FIG. 1 which shows a hydraulic brake system for vehicles for performance of the method according to the invention.

### DETAILED DESCRIPTION OF THE INVENTION

The brake system 1 shown in FIG. 1 shows only a single brake circuit connected to a brake cylinder 9 (tandem master cylinder for a front left wheel 10 and a rear right wheel 11, the second brake circuit is constructed accordingly and where applicable connected to the brake cylinder 9 via a hydraulic line connected with a valve block 12. The wheel brakes 2 and 2′ of wheels 10 and 11 with a brake caliper are also connected to this valve block 12 via hydraulic lines.

The brake system 1 further includes a brake servo (or booster) 13 connected with the brake cylinder 9 and a storage reservoir 5 for the brake fluid or hydraulic fluid. The brake cylinder 9 on the outlet side generates a brake pressure corresponding to movement of a brake pedal (not shown) which is connected with the brake servo 13 and is activated by a driver. This brake pressure is supplied to open inlet valves 7 and 7′ on the inlet side via an opened isolating valve 15, so that a corresponding brake pressure can be built up at the wheels 10 and 11 by means of brake calipers 2 and 2′. The two inlet valves 7 and 7′ are usually open when not powered up (i.e. normally open).

Outlet valves 8 and 8′, are usually closed when not powered up (i.e. normally closed), and connect the wheel brake 2 or 2′ with a low pressure accumulator 14 which in turn is connected on the suction side with a hydraulic pump 3 and can be connected with the brake cylinder 9 via a switch-over valve 6.

The hydraulic pump 3 is provided for wheel brakes 2 and 2′ in order, for example in the case of ABS (Antilock Brake System) or ESP (Electronic Stability Program) intervention, to redeliver the brake medium displaced into the low pressure accumulator when the pressure is relieved.

The hydraulic pump 3, or an eccentric pump arranged in or on the valve block 12, is driven by an electric motor 4 which in turn is controlled by a control unit (not shown) with pulse width modulation (PWM). The electric motor 4 is controlled here such that the hydraulic pump 3, by drawing in brake fluid on the suction side, can build up a brake pressure on the high-pressure side.

The hydraulic pump 3 is fitted with a position sensor which detects the position i.e. the rotational position of a rotating eccentric pump part of the hydraulic pump 3. This position sensor can be positioned both in or on the hydraulic pump 3 or also in the electric motor 4. Thus after controlling the electric motor 4 in stepper motor operation by means of a PWM pulse causing a specific rotation of the pump part, the new rotational position can be detected by means of the position sensor 16 and, together with the rotational position determined before rotation, the actual rotational angle can be determined. With the known rotational angle, not only can the expelled volume of hydraulic fluid be calculated but also the volume drawn in by the hydraulic pump 3 via the hydraulic connection to the pressure chamber of the brake caliper 2 or 2′. The hydraulic connection to the pressure chamber is created via an opened outlet valve 8 or 8′.

Thus by controlling the rotational angle with corresponding control of the electric motor 4, a volume proportional to the rotational angle can be drawn in from the pressure chamber of the brake caliper 2 or 2′, whereby because of the resulting reduced pressure in the pressure chamber, the brake piston is retracted by a defined extent. The extracted volume can be converted into a brake play because of the known cross sectional areas of the pistons.

Because the hydraulic pump 3 is controlled in stepper motor operation, the volume drawn in from the pressure chamber can be portioned sufficiently small so that the desired brake play can be set with high precision.

The brake play is adjusted for example after each braking process performed by the driver, after the pressure has been relieved in the wheel brakes 2 and 2′ and hence no more brake pressure is present.

First by means of the position sensor 16 the rotational position of the hydraulic pump 3 is established, then the electric motor 4 is controlled with a PWM pulse with a predefined pulse-duty factor, wherein the PWM pulse corresponds to a target rotational angle predefined by the control unit so that the volume necessary to achieve the desired brake play can be drawn in via the outlet valve 8 when the inlet valve 7 is closed, and delivered to the brake circuit in front of the inlet valve 7 so that it can flow back to the storage reservoir 5 via the brake cylinder 9.

Control with a specified PWM pulse causes a rotation of the hydraulic pump 3 into a rotational position which is established by means of the position sensor 16 to determine the actual rotational angle, i.e. its actual value. Depending on the deviation of the actual rotational angle from the target rotational angle, the electric motor is controlled by means of a further PWM pulse with greater pulse-duty factor. This control is continued until an actual-target value correlation exists within the limits of a predefined tolerance.

In order to be able, in control of the hydraulic pump 3 in stepper motor operation, to extract brake fluid from the pressure chamber of the brake caliper 2 or 2′, the switch-over valve 6 and the inlet valve 7 or 7′ are closed while outlet valve 8 or 8′ is opened to create the connection to the pressure chamber.

This method for adjusting brake play can be carried out per axle or per individual wheel when the driver is not activating the brake.

It is suitable to perform this process only when a positive engine moment is present.

If the method is executed after each braking process by the driver, the vehicle should not be at a standstill.

The method can naturally also be performed after an active build-up of brake pressure.

The method is stored in the control unit of the brake system as an algorithm.

By means of the position sensor 16 arranged in or coupled to the hydraulic pump 3, the low pressure accumulator 14 can also be protected when this is empty or almost empty and therefore no return delivery of brake medium to the brake circuit is possible. The volume extracted from the low pressure accumulator 14 can also be determined from the rotational positions of the hydraulic pump 3 detected by means of the position sensor 16. To prevent uncontrolled retraction of the brake piston, the outlet valve is closed when a wheel cylinder pressure lying close to 0 bar is detected by a corresponding sensor or pressure model.

While the above description constitutes the preferred embodiment of the present invention, it will be appreciated that the invention is susceptible to modification, variation and change without departing from the proper scope and fair meaning of the accompanying claims.

1. A method for adjusting the brake play in a hydraulic brake system for a motor vehicle of the type having at least one brake caliper with a brake piston which can be brought into friction engagement with a brake means,
a hydraulic pump which can be hydraulically connected with a pressure chamber of the brake caliper to move the brake piston, and an electric motor driving the hydraulic pump, which sets in rotational motion a pump part of the pump which can rotate to deliver brake medium to the brake caliper, comprising the following steps:
detecting a first rotational position of the pump part by means of a position sensor associated with the hydraulic pump,
generating a reduced pressure in the pressure chamber, which causes a reset of the piston, by suction of a volume of the brake medium determined by a predefined target rotational angle of the pump part, from the pressure chamber via a suction-side hydraulic connection with the pressure chamber, and by controlling the electric motor in stepper motor operation by means of a PWM signal as a controlled variable, the predefined target rotational angle of the pump part causes a rotation of the pump part into a second rotational position, wherein the second rotational position is detected by means of the position sensor, and the controlled variable is determined depending on the deviation of an actual rotational angle of the pump part, determined based on the second rotational position, from the target rotational angle.

2. The method as claimed in claim 1, further comprising in that the generating a reduced pressure in the pressure chamber step begins with the PWM signal having a predefined pulse-duty factor as the controlled variable, and the PWM signals of successive control steps have increasing pulse-duty factors.

3. The method as claimed in claim 1 further comprising providing a storage reservoir of the hydraulic brake system which is isolated from the hydraulic pump via a switch-over valve during the method steps of detecting a first rotational position of the pump and generating a reduced pressure.

4. The method as claimed in claim 1, further comprising an inlet valve connected with the pressure chamber of the brake caliper and closing the inlet valve during the steps of detecting a first rotational position and generating a reduced pressure.

5. The method as claimed in claim 1 further comprising providing an outlet valve connected with the pressure chamber of the brake caliper and opening the outlet valve during the method steps of detecting a first rotational position and generating a reduced pressure.

6. The method as claimed in claim 1 further comprising in that the method steps of detecting a first rotational position and generating a reduced pressure are performed after each of a braking process or after each of an active brake pressure build-up.

7. The method as claimed in claim 1 further comprising arranging the position sensor on the hydraulic pump or in the electric motor.

8. The method as claimed in claim 1 further comprising providing the position sensor in the form of an inductive sensor.
